(19) United States
(12) Patent Application Publication
(10) Pub. No.: US 2020/0285184 A1
(43) Pub. Date: Sep. 10, 2020

(54) SHEET FEEDER, IMAGE FORMING DEVICE, WEAR DETECTION METHOD AND NON-TRANSITORY RECORDING MEDIUM

(71) Applicant: Konica Minolta, Inc., Tokyo (JP)

(72) Inventor: Masatoshi Hitaka, Toyokawa-shi (JP)

(73) Assignee: Konica Minolta, Inc., Tokyo (JP)

(21) Appl. No.: 16/787,100

(22) Filed: Feb. 11, 2020

(30) Foreign Application Priority Data
Mar. 4, 2019 (JP) 2019-038231

(51) Int. Cl. G03G 15/00

(52) U.S. Cl. CPC G03G 15/55; G03G 15/6529

(57) ABSTRACT

A sheet feeder includes: a tray in which sheets are stored; a feeding part that feeds the sheets in the tray; and a hardware processor that: measures a conveyance speed of the sheets fed by the feeding part; compares the measured conveyance speed with a first standard speed and detects wear in the feeding part; detects an interval between a previous sheet and a following sheet when the following sheet is continuously fed after the previous sheet; and carries out a control to change the conveyance speed of the sheet from a predetermined speed based on the detected interval to correct the interval between the previous sheet and the following sheet. The hardware processor detects the wear in the feeding part based on the conveyance speed measured while the control to change the conveyance speed is not carried out.

### BACKGROUND

### Technological Field

The present invention relates to a sheet feeder, an image forming device, a wear detection method and a non-transitory recording medium. One or more embodiments of the present invention more specifically relate to a technique for detecting wear and a deterioration of a sheet feeding mechanism that feeds sheets.

### Description of the Related Art

Image forming devices such as printers or MFPs (Multifunction Peripherals) includes a sheet feeder that feeds sheets such as print papers. The sheet feeder includes a sheet feeding mechanism to send out the sheet. The sheet feeding mechanism rotates a sheet feeding roller in a predetermined direction so that the sheet is fed toward a predetermined carrying path. When a sheet feeding operation is repeatedly performed in the sheet feeder, parts such as the sheet feeding roller is worn out and deteriorated, resulting in lower sheets conveyance capacity of the sheet feeding mechanism. If wear and the deterioration status of the sheet feeding mechanism is left as it is, jams easily occur in feeding of sheets.

Conventional image forming devices that are enabled to detect wear and deterioration of the sheet feeding mechanisms are known. This known technique is introduced for example in Japanese Patent Application Laid-Open No. JP 2001-341894 A. According to the known technique, the conventional image forming device is provided with two sensors in downstream side of the sheet feeding roller. The image forming device measures a feeding time required for a passage of the sheet between two sensors after start of the sheet feeding operation to detect wear and the deterioration status of the sheet feeding mechanism.

The above-described feeding time varies depending on deceleration control carried out after start of the sheet feeding operation. The deceleration control is to temporarily reduce a conveyance speed of a following sheet when an interval between a previous sheet and the following sheet is shorter than a predetermined interval at continuous feeding of the sheets and amend the interval of the sheets to be longer than the predetermined interval. To be more specific, if the interval of the sheet gets shorter than the predetermined interval, jams are likely to occur. The deceleration control is carried out to widen the interval of the sheets so that occurrence of jams can be avoided. The deceleration control thereby carried out causes the variation of the feeding time required for the passage of the sheet between the two sensors in downstream side of the sheet feeding roller. The variation of the feeding time does not enable accurate detection of wear and deterioration status of the sheet feeding mechanism.

### SUMMARY

One or more embodiments provide a sheet feeder, an image forming device, a wear detection method and a non-transitory recording medium that distinguish between cases that control to change a conveyance speed of a sheet is carried out and not during a feeding operation of the sheet to accurately detect wear and deterioration status of a sheet feeding mechanism.

In one aspect, the present invention is directed to a sheet feeder.

According to an aspect of the present invention, the sheet feeder comprises: a tray in which multiple numbers of sheets are stored; a feeding part that feeds the sheet stored in the tray; and a hardware processor that: measures a conveyance speed of the sheet fed by the feeding part; compares the measured conveyance speed with a first standard speed and detects wear in the feeding part; detects an interval between the previous sheet and the following sheet when the following sheet is continuously fed after the previous sheet by the feeding part; and carries out a control to change the conveyance speed of the sheet from a predetermined speed based on the detected interval between the sheets so that the interval between the previous sheet and the following sheet is corrected. The hardware processor detects wear in the feeding part based on the conveyance speed measured while (i.e., during the time that) the control to change the conveyance speed of the sheet is not carried out.

In another aspect, the present invention is directed to an image forming device.

According to an aspect of the present invention, the image forming device comprises: a sheet feeder; and an image forming part that forms an image on a sheet fed by the sheet feeder. The sheet feeder comprises: a tray in which multiple numbers of sheets are stored;
a feeding part that feeds the sheet stored in the tray; and a hardware processor that: measures a conveyance speed of the sheet fed by the feeding part; compares the measured conveyance speed with a first standard speed and detects wear in the feeding part; detects an interval between the previous sheet and the following sheet when the following sheet is continuously fed after the previous sheet by the feeding part; and carries out a control to change the conveyance speed of the sheet from a predetermined speed based on the detected interval between the sheets so that the interval between the previous sheet and the following sheet is corrected. The hardware processor detects wear in the feeding part based on the conveyance speed measured while (i.e., during the time that) the control to change the conveyance speed of the sheet is not carried out.

In another aspect, the present invention is directed to a wear detecting method to detect a wear and deterioration status of a feeding part. The method is applied at an image forming device comprising: a tray in which multiple numbers of sheets are stored; and the feeding part that feeds the sheet stored in the tray.

According to an aspect of the present invention, the wear detecting method comprises: measuring a conveyance speed of the sheet fed by the feeding part; comparing the measured conveyance speed with a standard speed and detecting wear in the feeding part; detecting an interval between the previous sheet and the following sheet when the following sheet is continuously fed after the previous sheet by the feeding part; and carrying out a control to change the conveyance speed of the sheet from a predetermined speed based on the detected interval between the sheets so that the interval between the previous sheet and the following sheet is corrected. Wear in the feeding part is detected based on the conveyance speed measured while (i.e., during the time that) the control to change the conveyance speed of the sheet is not carried out.

In another aspect, the present invention is directed to a non-transitory recording medium storing a computer readable program to be executed by a hardware processor in an image forming device comprising: a tray in which multiple numbers of sheets are stored; and a feeding part that feeds the sheet stored in the tray.

According to an aspect of the present invention, the non-transitory recording medium storing a computer readable program to be executed by the hardware processor in the image forming device causing the hardware processor to perform: measuring a conveyance speed of the sheet fed by the feeding part; comparing the measured conveyance speed with a standard speed and detecting wear in the feeding part; detecting an interval between the previous sheet and the following sheet when the following sheet is continuously fed after the previous sheet by the feeding part; and carrying out a control to change the conveyance speed of the sheet from a predetermined speed based on the detected interval between the sheets so that the interval between the previous sheet and the following sheet is corrected. Wear in the feeding part is detected based on the conveyance speed measured while (i.e., during the time that) the control to change the conveyance speed of the sheet is not carried out.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary conceptual configuration of an image forming device;

FIG. 2 illustrates an example of an enlarged sheet feeding mechanism;

FIG. 3 illustrates a block diagram showing an example of a hardware structure and a functional structure of a controller;

FIG. 4 illustrates a timing that a sheet feeding sensor and a sheet passing sensor detect a sheet;

FIGS. 5A and 5B illustrate an example of a deceleration control carried by a sheet interval controller;

FIG. 6 illustrates a flow diagram explaining an exemplary procedure of the process performed in the image forming device of the first embodiment;

FIG. 7 illustrates a flow diagram explaining an exemplary procedure of a wear and deterioration detection in detail;

FIG. 8 illustrates a flow diagram explaining an exemplary procedure of the process performed in the image forming device of a second embodiment;

FIG. 9 illustrates a block diagram showing an example of a hardware structure and a functional structure of the controller of a third embodiment;

FIG. 10 illustrates a flow diagram explaining an exemplary procedure of the process performed in the image forming device of the third embodiment;

FIG. 11 illustrates a flow diagram explaining an exemplary procedure of a carrying out rate calculation in detail;

FIG. 12 illustrates an example of an acceleration control carried out by the sheet interval controller;

FIG. 13 illustrates a block diagram showing an example of a hardware structure and a functional structure of the controller of a fifth embodiment;

FIG. 14 illustrates a flow diagram explaining an exemplary procedure of the process performed in the image forming device of the fifth embodiment;

FIG. 15 illustrates an example of a control time during the deceleration control carried out by the sheet interval controller; and

FIG. 16 illustrates an example of multiple determination standard values stored in advance as a second standard speed.

### DETAILED DESCRIPTION OF EMBODIMENTS

Hereinafter, embodiments of the present invention will be described with reference to the drawings. However, the scope of the invention is not limited to the disclosed embodiments.

### First Embodiment

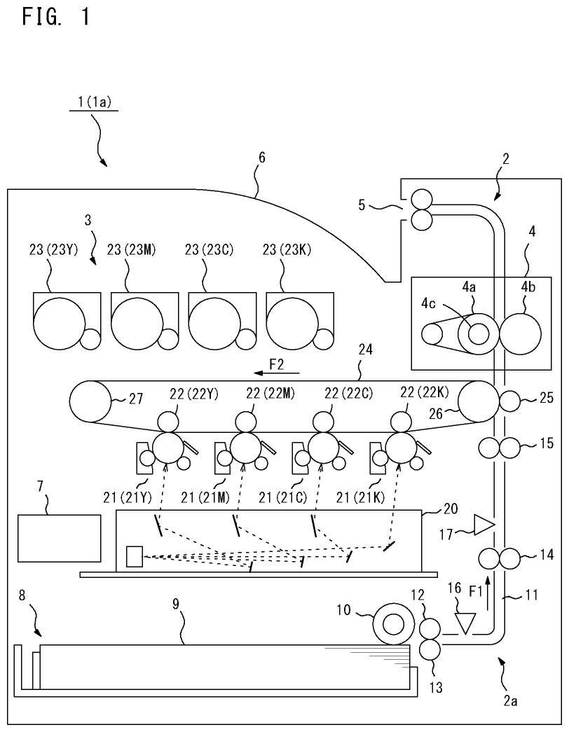

FIG. 1 illustrates an exemplary conceptual configuration of an image forming device 1 in which the first embodiment of the present invention may be practiced. The image forming device 1 of FIG. 1 is a printer capable of forming color images in tandem system. The image forming device 1 includes a function as a sheet feeder 1a that feeds a sheet 9 such as a print paper. The image forming device 1 forms a color image or a black and white image on the sheet 9 fed by the sheet feeder 1a, and delivers the sheet 9 on a sheet delivery tray 6 from a sheet delivery port 5 provided in an upper part of a device body. The image forming device 1 includes a sheet feeding unit 2, an image forming unit 3 and a fixing unit 4 inside the device body. The image forming device 1 brings the aforementioned parts into operation to form the image on the sheet 9. The image forming device 1 includes a controller 7 inside the device body. The controller 7 controls operations of each part such as the sheet feeding unit 2, the image forming unit 3 and the fixing unit 4. The functions of the sheet feeding unit 2 and the controller 7 enable the image forming device 1 to operate as the sheet feeder 1a.

The sheet feeding unit 2 includes a sheet feeding tray 8, a sheet feeding mechanism (feeding part) 2a, a carrying path 11, a timing roller 15 and a secondary transfer roller 25.

The sheet feeding tray 8 is a container in which multiple numbers of the sheets 9 such as the print papers are stored. The sheets 9 storable in the sheet feeding tray 8 are of great variety. The sheets 9 include thin papers, thick papers, plain papers, recycled papers, coated papers and OHP films, for instance. In the example of FIG. 1, a single sheet feeding tray 8 is provided with the image forming device 1. The number of the sheet feeding tray 8 is not limited to one. Multiple sheet feeding trays 8 may be provided in multi-stages.

The sheet feeding mechanism 2a picks up the sheet 9 stored in the sheet feeding tray 8 and feeds out to the carrying path 11. The detailed structure of the sheet feeding mechanism 2a is explained later. The carrying path 11 is a path to carry the sheet 9 in an arrow Fl direction when the image forming device 1 forms an image on the sheet 9. When a leading end of the sheet 9 carried along the carrying path 11 reaches the timing roller 15, the sheet feeding unit 2, for example, temporarily stops the sheet 9 at the timing roller 15. The sheet feeding unit 2 then drives the timing roller 15 in accordance with a timing that a toner image formed on an intermediate transfer belt 24 reaches a position of the secondary transfer roller 25 in the image forming unit 3, and carries the sheet 9 to the position of the secondary transfer roller 25. As a result, the toner image is transferred to a surface of the sheet 9 when the sheet 9 passes through the position of the secondary transfer roller 25. The sheet 9 is led to the fixing unit 4 and the toner image is fixed. The sheet 9 is then delivered from the delivery port 5. The carrying path 11 of FIG. 1 shows a carrying path for forming an image only on a surface of the sheet 9. However, this is given not for limitation. To be more specific, the carrying path 11 may further include a sheet inversion path for forming an image on a rear of the sheet 9.

The image forming unit 3 forms toner images of four colors, Y (yellow), M (magenta), C (cyan) and K (black), and transfers the toner images of the four colors at the same time on the sheet 9 passing through the position of the secondary transfer roller 25. The image forming unit 3 includes an exposure unit 20, a developing unit 21, a primary transfer roller 22, the intermediate transfer belt 24 and toner bottles 23 of the respective colors. The developing unit 21 is provided for the toners of the respective colors. The primary transfer roller 22 is provided corresponding to each developing unit 21. Four developing units 21Y, 21M, 21C and 21K are provided in a lower position of the intermediate transfer belt 24. The exposure unit 20 is arranged in a further lower position of the four developing units 21Y, 21M, 21C and 21K. Each of toner bottles 23Y, 23M, 23C and 23K supplies the toner of each color to the corresponding developing unit 21Y, 21M, 21C or 21K.

The exposure unit 20 exposures an image carrier (a photoreceptor drum) provided with each developing unit 21Y, 21M, 21C and 21K, and forms a latent image on the image carrier of each developing unit 21Y, 21M, 21C and 21K. Each developing unit 21Y, 21M, 21C and 21K develops the latent image with the toner so that the toner image is formed on a surface of the image carrier. Each developing unit 21Y, 21M, 21C and 21K then superposes the toner image of each color one after another on the intermediate transfer belt 24 which is circulated and moved in an arrow direction F2 to enable primary transfer. When the intermediate transfer belt 24 passes through the position of the developing unit 21K which is at downstream end, a color image which is superposing the toner images of four colors is formed on the surface of the intermediate transfer belt 24. The toner image formed on the intermediate transfer belt 24 is in contact with the sheet 9 carried by the sheet feeding unit 2 and secondarily transferred on the surface of the sheet 9 when passing through a position facing the secondary transfer roller 25.

The fixing unit 4 includes a heating roller 4a and a pressure roller 4b. The fixing unit 4 enables the sheet 9 to which the toner image is transferred to go through between the heating roller 4a and the pressure roller 4b, and performs a heating operation and a pressure operation on the sheet 9. The fixing unit 4 then fixes the toner image to the sheet 9.

The heating roller 4a includes a heater 4c. Temperature of the heating roller 4a rises due to heating of the heater 4c. The sheet 9 with the toner image fixed in the fixing unit 4 is then delivered on the sheet delivery tray 6 from the delivery port 5 via the carrying path 11.

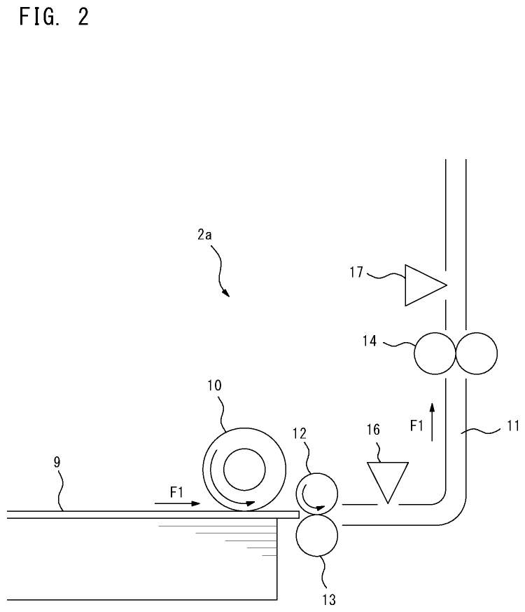

The detail of the sheet feeding mechanism 2a is explained next. FIG. 2 illustrates an example of the enlarged sheet feeding mechanism 2a. As illustrated in FIG. 2, the sheet feeding mechanism 2a includes a pick-up roller 10, a sheet feeding roller 12, a separation roller 13, a carrying roller 14, a sheet feeding sensor 16 and a sheet passing sensor 17 along with the carrying path 11 to carry the sheet 9. The carrying roller 14 may be driven separately from the sheet feeding roller 12.

The pick-up roller 10 takes the sheet 9 from a top of the bundle of the sheets 9 stored in the sheet feeding tray 8, and feeds out toward the carrying path 11. The pick-up roller 10 is in contact with the sheet 9 which is placed on a top of the bundle of the sheets 9, and is rotated and driven in a direction shown with an arrow of FIG. 2 (counterclockwise direction) by a motor which is not shown in FIG. 2. To be more specific, the pick-up roller 10 is rotated and driven in response to starting the sheet feeding operation at the image forming device 1, and feeds out the sheet 9 placed on the top toward downstream side. When the second sheet 9 following the first sheet 9 placed on the top may also be fed together with the first sheet 9 toward downstream side.

The sheet feeding roller 12 and the separation roller 13 are arranged in downstream side from the pick-up roller 10. The sheet feeding roller 12 and the separation roller 13 are a pair related to each other. When more than two sheets 9 are multifed by the pick-up roller 10, the sheet feeding roller 12 and the separation roller 13 work in cooperation with each other to only separate the first sheet 9 on the top and feed out the first sheet 9 toward downstream side. More specifically, the sheet feeding roller 12 is arranged oppositely to the separation roller 13 across the carrying path 11. The sheet feeding roller 12 and the separation roller 13 stop feeding out the sheet 9 after the second one of the multiple sheets 9 fed out at the same time from the sheet feeding tray 8 by the pick-up roller 10 and only carry the first sheet 9 on the top to downstream.

The sheet feeding roller 12 is placed on an upper side of the carrying path 11. The sheet feeding roller 12 is rotated and driven in a direction shown with an arrow of FIG. 2 (counterclockwise direction) by the motor which is not shown in FIG. 2. The separation roller 13 is placed at a lower side of the carrying path 11. The separation roller 13 is rotated in accordance with the rotation of the sheet feeding roller 12. The separation roller 13 is constructed to enable a rotation axis to produce a predetermined frictional force to a bearing. The sheet feeding roller 12 rotates the separation roller 13 in accordance with its rotation against the produced frictional force when rotating the separation roller 13 in accordance with its rotation.

When the single sheet 9 is sent from the sheet feeding tray 8 by the pick-up roller 10, the sheet feeding roller 12 and the separation roller 13 hold the single sheet 9 and send out the single sheet 9 toward downstream side. The sheet feeding roller 12 gets in contact with the top surface of the sheet 9 and rotates in the counterclockwise direction to apply a conveyance force toward downstream side to the sheet 9 so that the sheet 9 is carried toward downstream side. The separation roller 13 gets in contact with the rear side of the sheet 9 and applies a frictional force to the sheet 9. The conveyance force applied by the sheet feeding roller 12 is larger than the frictional force applied by the separation roller 13. The separation roller 13 rotates in accordance with the passage of the sheet 9.

On the other hand, more than two sheets 9 may be multifed from the sheet feeding tray 8 by the pick-up roller 10. In such a case, the sheet feeding roller 12 is in contact with the top surface of the first sheet 9 placed uppermost and only sends the first sheet 9 toward downstream side. The rear side of the sheet 9 after the second one gets in contact with the separation roller 13 so that it stops in response to the frictional force applied by the separation roller 13. The separation roller 13 does not rotate in response to the passage of the sheet 9 so that only the uppermost first sheet 9 is carried toward downstream side.

When the carrying path 11 receives the sheet 9 fed from the sheet feeding roller 12 and the separation roller 13 in a horizontal direction, it carries the sheet 9 in a vertical direction. The carrying roller 14 is provided with the carrying path of the vertical direction. The carrying roller 14 includes a pair of rollers arranged across the carrying path 11. The carrying roller 14 is rotated and driven by a motor which is not shown in FIG. 2 to carry the sheet 9 to an upper direction.

The sheet feeding sensor 16 is provided at downstream from the sheet feeding roller 12 and the separation roller 13. The sheet feeding sensor 16 detects the sheet 9 sent out to downstream side of the sheet feeding roller 12 at a predetermined position.

The sheet passing sensor 17 is provided at further downstream from the sheet feeding sensor 16. The sheet passing sensor 17 of the first embodiment is provided at a predetermined position which is at downstream side of the carrying roller 14 and at upstream side of the aforementioned timing roller 15. The sheet passing sensor 17 detects the sheet 9 sent toward downstream side by the sheet feeding roller 12 and the carrying roller 14 at a predetermined position, as well as the sheet feeding sensor 16.

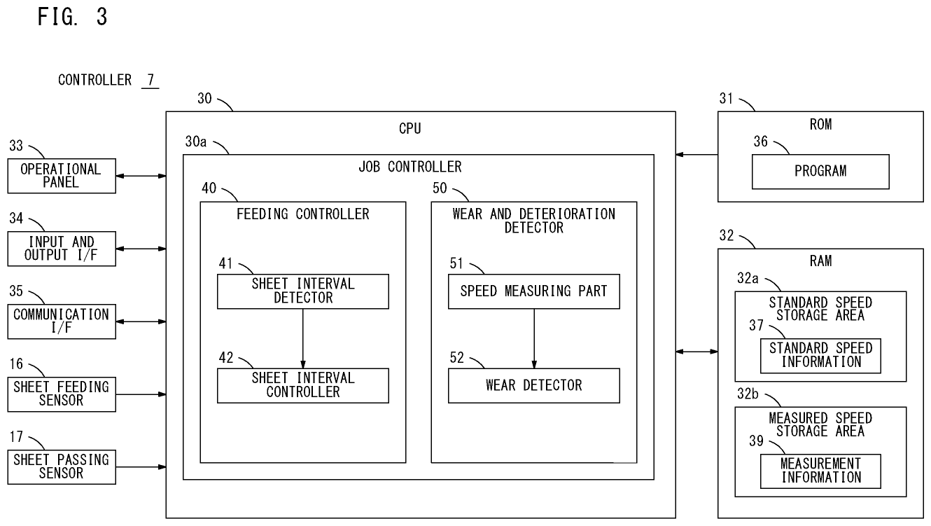

FIG. 3 illustrates a block diagram showing an example of a hardware structure and a functional structure of the controller 7. The controller 7 mainly includes a CPU (hardware processor) 30, a ROM 31 and a RAM 32 as illustrated in FIG. 3. The controller 7 is connected to an operational panel 33 by using which a user is enabled to configure a variety of settings. The controller 7 is enabled to configure the variety of settings based on user's operations input via the operational panel 33. Moreover, an input and output interface 34, a communication interface 35, the aforementioned sheet feeding sensor 16 and the aforementioned sheet passing sensor 17 are connected to the controller 7. The input and output interface 34 is to input and output signals to the respective aforementioned sheet feeding unit 2, image forming unit 3 and fixing unit 4, and the communication interface 35 is to communicate with an external device connected over a network such as LAN (Local Area Network).

The CPU 30 is an arithmetic processor that executes a certain program 36. The ROM 31 is a non-volatility memory that stores therein the program 36 in advance. The RAM 32 is a rewritable memory, for instance, and is used by the CPU 30 to store temporal data. The RAM 32 includes a standard speed storage area 32a and a measured speed storage area 32b, for instance. Other than the standard speed storage area 32a and the measured speed storage area 32b, there are several areas to store a variety of information in the RAM 32.

Standard speed information 37 is stored in advance in the standard speed storage area 32a. A standard value of the conveyance speed of the sheet 9 fed when the sheet feeding roller 12 is not worn out is stored as the standard speed information 37. The conveyance speed of the sheet 9 and time required for passage of the sheet 9 for a certain distance are related to correlation. According to the first embodiment, a standard value of a sheet passing time required for passage between the positions of the sheet feeding sensor 16 and the sheet passing sensor 17 when the sheet 9 is carried at a certain conveyance speed while the sheet feeding roller 12 is not worn out is recorded as the standard speed information 37 as a standard value of the conveyance speed.

A measurement information 39 is stored in the measured speed storage area 32b. The conveyance speed of the sheet 9 measured when the sheet 9 is fed is recorded as the measurement information 39. As described above, the conveyance speed of the sheet 9 and the time required for passage of the sheet 9 for the certain distance are related to correlation. The image forming device 1 of the first embodiment measures the sheet passing time required for passage of the sheet 9 after passage of the position of the sheet feeding sensor 16 to passage of the position of the sheet passing sensor 17 when the sheet 9 is fed by the sheet feeding roller 12. An accumulated value of the sheet passing time (cumulative time) is recorded as the measurement information 39.

The CPU 30 reads and executes the program 36 in the ROM 31 so that it serves as a job controller 30a. The job controller 30a controls processing of a print job in the image forming device 1. In response to receiving the print job via the communication interface 35, for example, the job controller 30a controls processing of the print job. More specifically, the job controller 30a controls operations of the sheet feeding unit 2, the image forming unit 3 and the fixing unit 4 via the input and output interface 34 to produce a printed output based on the received print job. The job controller 30a includes a feeding controller 40 and a wear and deterioration detector 50.

The feeding controller 40 controls the operations of the sheet feeding mechanism 2a in response to processing of the print job so that it enables the sheet 9 stored in the sheet feeding tray 8 to be carried to the carrying path 11. To explain in detail, when it is detected by the job controller 30a that it is a sheet feeding timing, the feeding controller 40 drives the motor that rotates the pick-up roller 10 and the sheet feeding roller 12 and starts the sheet feeding operation to feed the sheet 9 to the carrying path 11 from the sheet feeding tray 8. The print job may be a job to continuously form an image on the multiple sheets 9, for example. In this case, the feeding controller 40 drives the sheet feeding mechanism 2a intermittently at predetermined intervals so that the multiple sheets 9 are continuously fed from the sheet feeding tray 8. Thus, the image is formed on each of the multiple sheets 9 one after the other. The feeding controller 40 as described above includes a sheet interval detector 41 and a sheet interval controller 42.

The sheet interval detector 41 detects the interval between the previous sheet and the following sheet when the following sheet is continuously fed after the previous sheet by the feeding controller 40. The sheet interval detector 41 measures the feeding time between the start of the sheet feeding operation by the feeding controller 40 and detection of the sheet 9 by the sheet feeding sensor 16 to detect the sheet interval.

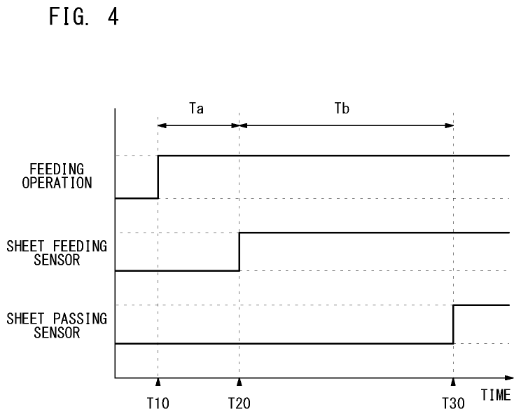

FIG. 4 illustrates a timing that the sheet feeding sensor 16 and the sheet passing sensor 17 detect the sheet 9. As illustrated in FIG. 4, the sheet feeding operation of the sheet 9 is started at timing T10, for instance, and the sheet 9 is detected by the sheet feeding sensor 16 at timing T20. The sheet 9 then detected by the sheet passing sensor 17 at timing T30. The sheet interval detector 41 measures a feeding time Ta between the timing T10 at which the sheet feeding operation is started and the timing T20 at which the sheet 9 is detected by the sheet feeding sensor 16.

The sheet 9 following the previous sheet 9 at the sheet feeding may not be miltifed. In this case, a leading end of the sheet 9 to be fed next is positioned on the sheet feeding tray 8. Once the feeding controller 40 starts the feeding operation for the next sheet 9, the sheet 9 moves toward the sheet feeding roller 12 from the sheet feeding tray 8. The sheet 9 then carried toward downstream side of the carrying path 11 by the sheet feeding roller 12. When the sheet 9 following the previous sheet 9 at the sheet feeding is not miltifed, the feeding time Ta between the start of the next sheet feeding operation and the detection of the leading end of the sheet 9 by the sheet feeding sensor 16 will be relatively long.

When the sheet 9 following the previous sheet 9 at the sheet feeding is miltifed, the leading end of the sheet 9 to be fed next is positioned somewhere between a position on the sheet feeding tray 8 and a position of the separation roller 13. To be more specific, if the following sheet 9 is multifed at the sheet feeding operation of the previous sheet 9, the initial position of the following sheet 9 would have been proceeded downstream side. Once the next sheet feeding operation is started by the feeding controller 40, the sheet 9 is carried toward downstream side of the carrying path 11 by the sheet feeding roller 12 in a relatively short time. Hence, when the sheet 9 following the previous sheet 9 is miltifed during the sheet feeding operation to feed the previous sheet 9, the feeding time Ta between the start of the next sheet feeding operation and the detection of the leading end of the sheet 9 by the sheet feeding sensor 16 will be relatively short.

The sheet interval detector 41 detects the interval between the previous sheet 9 and the following sheet 9 based on the feeding time Ta as described above. When the interval between the previous sheet 9 and the following sheet 9 is shorter than a predetermined interval, the leading end of the following sheet 9 catches up the rear end of the previous sheet 9, resulting in occurrence of a jam. The sheet interval detector 41 determines if the interval between the previous sheet 9 and the following sheet 9 is shorter than the predetermined interval. To explain more in detail, the sheet interval detector 41 compares the measured feeding time Ta with an appropriate time Tx which is set in advance. If the feeding time Ta is shorter than the appropriate time Tx, the sheet interval detector 41 determines the interval between the sheets is shorter than the predetermined interval. When determining the interval between the sheets is shorter than the predetermined interval, the sheet interval detector 41 brings the sheet interval controller 42.

The sheet interval controller 42 controls to change the conveyance speed of the sheet 9 fed by the feeding controller 40 (speed change control) so that the interval between the sheets is corrected. The sheet interval detector 41 determines that the interval between the sheets is shorter than the predetermined interval, the sheet interval controller 42 of the first embodiment carries out a deceleration control to reduce the conveyance speed of the following sheet 9. As a result, the interval between the previous sheet 9 and the following sheet 9 is widened so that the occurrence of the jam may be prevented. The sheet interval controller 42 of the first embodiment immediately carries out the deceleration control to reduce the conveyance speed of the following sheet 9 when it is determined that the interval between the sheets is shorter than the predetermined interval. The sheet interval controller 42 may carry out the deceleration control after the sheet 9 passes through the sheet feeding sensor 16 until the sheet 9 reaches the sheet passing sensor 17.

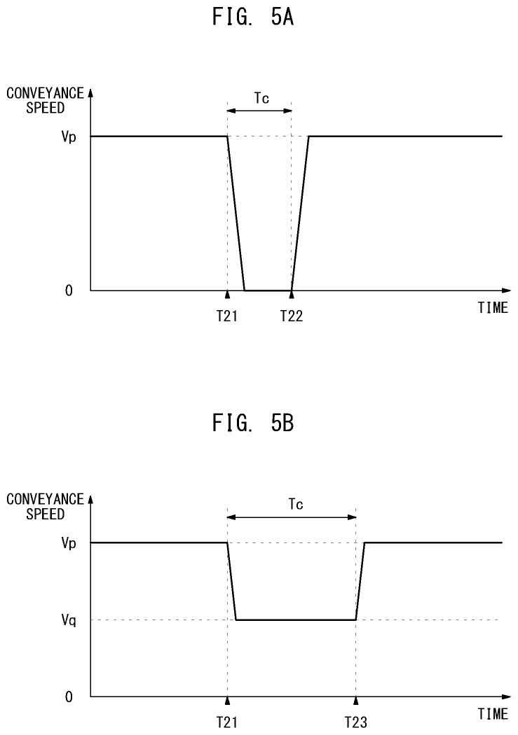

FIGS. 5A and 5B illustrate an example of the deceleration control. For starting the sheet feeding operation and carrying the sheet 9, the feeding controller 40 drives the sheet feeding roller 12 to enable the conveyance speed of the sheet 9 to be a predetermined speed Vp as illustrated in FIG. 5A. After the sheet feeding operation by the feeding controller 40 is started, the interval between the sheets shorter than the predetermined interval may be detected by the sheet interval detector 41. The sheet interval controller 42 then starts the deceleration control at timing T21. The sheet interval controller 42 determines a controlling time Tc to carry out the deceleration control depending on the interval between the sheets detected by the sheet interval detector 41. The sheet interval controller 42 maintains the conveyance speed of the sheet 9 lower than the predetermined speed Vp until elapse of the controlling time Tc from the start of the deceleration control. The sheet interval controller 42 then returns the conveyance speed of the sheet 9 back again to the predetermined speed Vp at time when the controlling time Tc is elapsed. The shorter interval between the sheets has longer controlling time Tc.

As illustrated in FIG. 5A, for example, the sheet interval controller 42 may set the conveyance speed of the sheet 9 to zero and temporarily terminate carrying the sheet 9 during the deceleration control. In this case, the control time Tc may be shortened. After starting the deceleration control at timing T21, the sheet interval controller 42 completes the deceleration control at timing T22 which is relatively early. The sheet interval controller 42 then controls to return the conveyance speed of the sheet 9 to the predetermined speed Vp.

As illustrated in FIG. 5B, for example, the sheet interval controller 42 may set the conveyance speed of the sheet 9 to a certain speed Vq which is lower than the predetermined speed Vp during the deceleration control, and continue carrying the sheet 9. The speed Vq, for example, may be approximately a half value of the speed Vp. The controlling time Tc, in this case, is set longer compared to the case where the conveyance of the sheet 9 is to be terminated. After starting the deceleration control at timing T21, the sheet interval controller 42 completes the deceleration control at timing T23 which is relatively late, and controls to return the conveyance speed of the sheet 9 back to the predetermined speed Vp.

The sheet interval controller 42 carries out the aforementioned deceleration control so that the interval between the previous sheet 9 and the following sheet 9 is widened and the following sheet 9 is carried toward downstream of the carrying path 11 with maintaining the certain interval between the previous sheet 9 and the following sheet 9.

The wear and deterioration detector 50 detects wear and deterioration status of the sheet feeding mechanism 2a including the sheet feeding roller 12 when the job controller 30a produces the printed output based on the print jog. The wear and deterioration detector 50 includes a speed measuring part 51 and a wear detector 52.

The speed measuring part 51 measures the conveyance speed of the sheet 9 fed when the sheet feeding mechanism 2a such as the sheet feeding roller 12 is driven. The conveyance speed of the sheet 9 and the time required for passage of the sheet 9 for the certain distance are related to correlation as described above. After the feeding of the sheet 9 is started by the feeding controller 40, the speed measuring part 51 measures the passing time required for the sheet 9 to pass between the sheet feeding sensor 16 and the sheet passing sensor 17 to measure the conveyance speed of the sheet 9. To be more specific, the speed measuring part 51 measures the time between timing T20 at which the sheet 9 is detected by the sheet feeding sensor 16 and timing T30 at which the sheet 9 is detected by the sheet passing sensor 17 as a sheet passing time Tb. The speed measuring part 51 measures the sheet passing time Tb for every sheet feeding operation performed by the sheet feeding controller 40. When the multiple sheets 9 are continuously fed by the sheet feeding controller 40, the speed measuring part 51 repeatedly performs a measurement of the sheet passing time Tb.

The wear detector 52 serves as a first wear detector. The wear detector 52 detects the wear and deterioration status of the sheet feeding mechanism 2a based on the sheet passing time Tb measured by the speed measuring part 51. To be more specific, the wear detector 52 compares the sheet passing time Tb measured by the speed measuring part 51 with the standard value of the sheet passing time stored as the standard speed information 37, and detects the wear and deterioration status of the sheet feeding mechanism 2a. If wear and deterioration status of the sheet feeding roller 12 is in progress, the conveyance force of the sheet 9 is reduced, and resulting in decrease in the conveyance speed of the sheet 9. The decrease in the conveyance speed of the sheet 9 extends the sheet passing time Tb. The wear detector 52, therefore, compares the sheet passing time Tb measured by the speed measuring part 51 with the standard value. When the sheet passing time Tb is more than the standard value, the wear detector 52 determines that the sheet feeding mechanism 2a is worn out. The wear detector 52 may determine that the sheet feeding mechanism 2a is worn out when the sheet passing time Tb is a predetermined period of time more than the standard value. The wear detector 52 as described above preferably determines that the sheet feeding mechanism 2a is worn out before occurrence of the jam due to wear of the sheet feeding mechanism 2a increases.

After determining the sheet feeding mechanism 2a is worn out, the wear detector 52 warns the user by notifying it is the time to replace the sheet feeding roller 12. The warning may be given through the operational panel 33 or an information device used by the user via the communication interface 35. As a result, the user is enabled to replace the sheet feeding mechanism 2a including the sheet feeding roller 12 at early stage before the jam frequently occurs. This enables to restrain the downtime of the image forming device 1 to the minimum.

When the sheet passing time Tb is measured by the speed measuring part 51, the deceleration control may be carried out by the sheet interval controller 42. The deceleration control carried out by the sheet interval controller 42 extends the sheet passing time Tb measured by the speed measuring part 51. The wear detector 52 of the first embodiment determines if the deceleration control to decrease the conveyance speed of the sheet is carried out by the sheet interval controller 42 during the sheet feeding operation. The wear detector 52 detects the wear and deterioration status of the sheet feeding mechanism 2a based on the sheet passing time Tb measured while the deceleration control is not carried out. In other words, the wear detector 52 of the first embodiment discards the sheet passing time Tb measured during the deceleration control carried out by the sheet interval controller 42 and only uses the sheet passing time Tb which is measured while the deceleration control is not carried out to detect the wear and deterioration status of the sheet feeding mechanism 2a. As a result, the deceleration control does not affect the sheet passing time Tb so that the wear detector 52 is enabled to accurately detect the wear and deterioration status of the sheet feeding mechanism 2a.

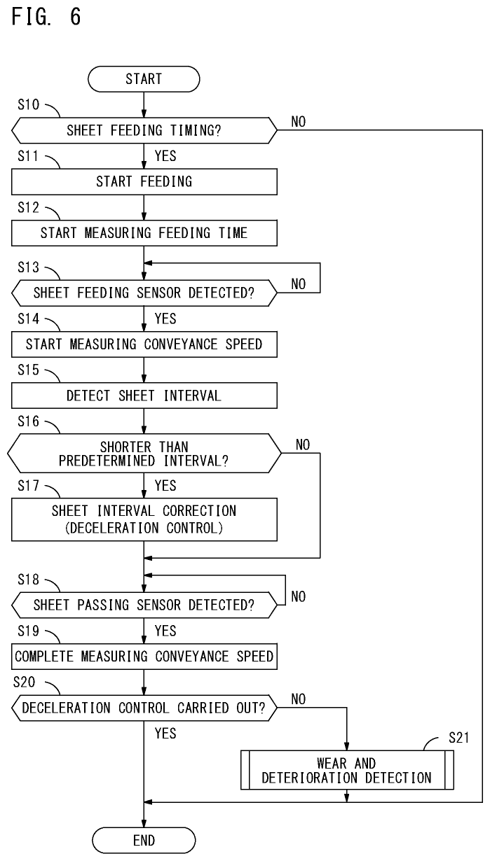

A detailed process sequence performed in the image forming device 1 is explained next. FIG. 6 illustrates a flow diagram explaining an exemplary procedure of the process performed in the image forming device 1 of the first embodiment. This process is repeatedly performed by the controller 7 when the print job is processed in the image forming device 1. Upon start of the process, the controller 7 determines if it is a sheet feeding timing to feed the sheet 9 (step S10). If it is not the sheet feeding timing, the process completes. If it is the sheet feeding timing (when a result of step S10 is YES), the controller 7 brings the feeding controller 40 into operation to start feeding the sheet 9 (step S11). When the feeding operation of the sheet 9 is started, the sheet interval detector 41 starts measuring the feeding time Ta (step S12). The sheet interval detector 41 waits until the sheet 9 is detected by the sheet feeding sensor 16 (into a loop when a result of step S13 is NO). Once the sheet 9 is detected (when a result of step S13 is YES), the sheet interval detector 41 completes measuring the feeding time Ta. When the sheet 9 is detected by the sheet feeding sensor 16, the speed measuring part 51 starts measuring the conveyance speed of the sheet 9 (step S14). To be more specific, the speed measuring part 51 starts measuring the sheet passing time Tb.

After measuring the feeding time Ta, the sheet interval detector 41 detects the interval between the previous sheet 9 and the following sheet 9 based on the feeding time Ta (step S15). The sheet interval detector 41 then determines if the interval between the sheets is shorter than the predetermined interval (step S16). When the sheet interval detector 41 determines that the interval between the sheets is shorter than the predetermined interval (when a result of step S16 is YES), the sheet interval controller 42 becomes operative. The sheet interval controller 42 corrects the interval between the sheets to an appropriate interval (step S17). To be more specific, in step S17, the deceleration control by the sheet interval controller 42 is carried out, and the deceleration control carried out by the sheet interval controller 42 causes the temporal decrease in the conveyance speed of the sheet 9.

When the interval between the sheets is not shorter than the predetermined interval (when a result of step S16 is NO), the process in step S17 is not carried out. In this case, the sheet 9 is carried maintaining the conveyance speed that corresponding to the wear and deterioration status of the part such as the sheet feeding roller 12.

After starting measurement of the sheet passing time Tb, the speed measuring part 51 waits until the sheet 9 is detected by the sheet passing sensor 17 (step S18). When the sheet 9 is detected by the sheet passing sensor 17 (when a result of step S18 is YES), the speed measuring part 51 completes the measurement of the conveyance speed (step S19). To be more specific, the speed measuring part 51 completes measurement of the sheet passing time Tb. The speed measuring part 51 outputs the measured sheet passing time Tb to the wear detector 52.

After obtaining the sheet passing time Tb, the wear detector 52 determines if the deceleration control is carried out by the sheet interval controller 42 during the sheet feeding operation of the sheet 9 (step S20). Upon determining that the deceleration control is carried out (when a result of step S20 is YES), the wear detector 52 discards the sheet passing time Tb measured by the speed measuring part 51 and completes the process. To be more specific, the process to detect the wear and deterioration status is not performed by the wear detector 52 this time.

On the other hand, the wear detector 52 may determine that the deceleration control is not carried out by the sheet interval controller 42 (when a result of step S20 is NO). In this case, the wear detector 52 performs a wear and deterioration detection (step S21). In this wear and deterioration detection, a predetermined number of the sheet passing times Tb measured while the deceleration control is not carried out, for instance, are stored, and an average of the predetermined number of the sheet passing times Tb is calculated once the predetermined number of passing times Tb are stored. It is determined if the sheet feeding mechanism 2a is worn out based on the calculated average.

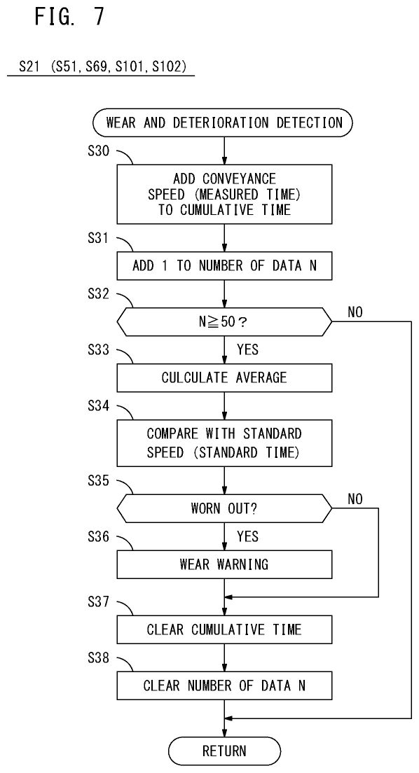

FIG. 7 illustrates a flow diagram explaining an exemplary procedure of the wear and deterioration detection (step S21) in detail. After starting the wear and deterioration detection, the wear detector 52 adds the sheet passing time Tb obtained from the speed measuring part 51 to a cumulative time of the sheet passing time Tb in the measured information 39 (step S30). The wear detector 52 adds 1 to the number of data N (step S31). The number of data N is a total number of data that is accumulated to the cumulative time of the passing time Tb. The wear detector 52 then determines if the number of data N is equal to or more than a predetermined number (for instance, 50) (step S32). If the number of data N is less than the predetermined number (when a result of step S32 is NO), the process by the wear detector 52 completes.

When the number of data N gets equal to or more than the predetermined number (when a result of step S32 is YES), the wear detector 52 divides the cumulative time of the measurement information 39 by the number of data N to obtain the average of the sheet passing time Tb (step S33). The wear detector 52 compares the average of the sheet passing time Tb with the standard value of the sheet passing time recorded as the standard speed information 37 (step S34), and determines if the sheet feeding mechanism 2a such as the sheet feeding roller 12 is worn out (step S35). When determining that the sheet feeding mechanism 2a is worn out (when a result of step S35 is YES), the wear detector 52 performs a wear warning (step S36). To be more specific, the wear detector 52 informs the user of the arrival of the replacement timing of the part such as the sheet feeding roller 12. When determining that the sheet feeding mechanism 2a is not worn out (when a result of step S35 is NO), the wear detector 52 skips the process in step S36. The wear detector 52 then clears and resets the cumulative time in the measurement information 39 (step S37), and clears and resets the number of data N (step S38). Hence, according to the first embodiment, every time the predetermined number (for instance, 50 times) of the sheet passing times Tb are measured while the deceleration control is not carried out by the sheet interval controller 42, the wear determination is performed by the wear detector 52. As described above, the process in the image forming device 1 is complete.

As described above, the image forming device 1 of the first embodiment detects wear of the sheet feeding mechanism 2a based on the conveyance speed of the sheet 9, measured by the speed measuring part 51, of the time when the control to change the conveyance speed of the sheet 9 by the sheet interval controller 42 is not carried out. In the other words, the image forming device 1 of the first embodiment does not use the conveyance speed measured while the control to change the conveyance speed of the sheet 9 is carried out by the sheet interval controller 42 for the detection of wear of the sheet feeding mechanism 2a. The image forming device 1 of the first embodiment is enabled to only take the conveyance speed not affected by the control by the sheet interval controller 42 into consideration to determine the wear and deterioration status of the sheet feeding mechanism 2a, resulting in accuracy in the determination.

As described above, the wear detector 52 determines whether or not the deceleration control is carried out during the measurement of the sheet passing time Tb after the measurement of the sheet passing time Tb by the speed measuring part 51. However, this is given not for limitation. The speed measuring part 51 may terminate the measurement of the sheet passing time Tb upon the start of the deceleration control by the sheet interval controller 42 during the measurement of the sheet passing time Tb, for example.

In the example described above, the sheet passing time Tb of the sheet 9 is added to the cumulative time in the measurement information 39. However, this is given not for limitation. The sheet passing times Tb for the predetermined number of times (for instance, 50 times) may be recorded as they are. In this case, the wear detector 52 may exclude the sheet passing times Tb showing the largest value and the smallest value among from the multiple sheet passing times Tb for the predetermined number of times from average calculation objects. This is to remove noise.

As described above, the wear and deterioration status of the feeding part may be detected by distinguishing two cases, where the control to change the conveyance speed of the sheet is carried out during the feeding operation of the sheet or where the control is not carried out. As a result, the wear and deterioration status of the feeding part may be detected accurately.

### Second Embodiment

The second embodiment of the present invention is explained next. In the above-described first embodiment, the wear detector 52 determines whether or not the deceleration control is carried out every time the sheet 9 is fed. According to the second embodiment, the wear and deterioration status is determined based on the sheet passing time Tb measured at the time when the first sheet 9 which is fed after the start of processing of the print job is fed. The structure of the image forming device 1 of the second embodiment is the same as that explained in the first embodiment.

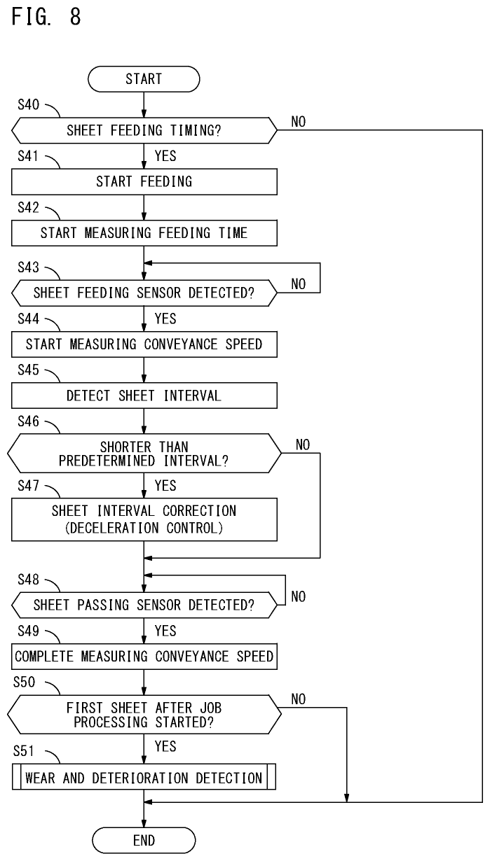

FIG. 8 illustrates a flow diagram explaining an exemplary procedure of the process performed in the image forming device 1 of the second embodiment. This flow diagram replaces the flow diagram in FIG. 6 explained in the first embodiment. The process in steps S40 to S49 in the flow diagram is the same as the process in steps S10 to S19 in the flow diagram of FIG. 6. To be more specific, after detecting that it is the sheet feeding timing, the controller 7 starts feeding the sheet 9 and measures the feeding time Ta. When the interval between the sheets is shorter than the predetermined interval, the controller 7 carries out the deceleration control. If the interval between the sheets is longer than the predetermined interval, the controller 7 does not carry out the deceleration control. Once the fed sheet 9 is detected by the sheet passing sensor 17 (when a result of step S48 is YES), the controller 7 completes the measurement of the conveyance speed of the sheet 9 (step S49). To be more specific, the controller 7 completes measuring the sheet passing time Tb which is correlated with the conveyance speed of the sheet 9.

After the sheet passing time Tb of the sheet 9 is measured, the wear detector 52 determines whether or not the sheet passing time Tb is for the first sheet 9 fed after the processing of the print job is started (step S50). If the sheet passing time Tb is for the first sheet 9 (when a result of step S50 is YES), the wear detector 52 performs the wear and deterioration detection (step S51). The detail of the wear and deterioration detection (step S51) is the same as that explained in the flow diagram of FIG. 7. More specifically, the wear detector 52 accumulates the sheet passing time Tb of the sheet 9 fed at first in response to the start of processing of the print job for the predetermined number of times. The wear detector 52 calculates the average of the predetermined number of times of the sheet passing times Tb, and determines the wear and deterioration status of the sheet feeding mechanism 2a based on the calculated average. When determining that the sheet feeding mechanism 2a is worn out, the wear detector 52 performs the wear warning to get the user to replace the sheet feeding mechanism 2a.

If the measured sheet passing time Tb is not the sheet passing time Tb for the first sheet 9 (when a result of step S50 is NO), the wear detector 52 discards the sheet passing time Tb measured by the speed measuring part 51 and completes the process. In this case, the wear and deterioration status is not detected by the wear detector 52.

As described above, the image forming device 1 of the second embodiment detects the wear and deterioration status of the sheet feeding mechanism 2a based on the sheet passing time Tb measured at the time when the first sheet 9 is fed after start of processing of the print job. There is no sheet on the carrying path 11 fed earlier than the first sheet 9 when the first sheet 9 is fed. In this case, the deceleration control is not carried out by the sheet interval controller 42. As a result, the image forming device 1 of the second embodiment is enabled to accurately detect the wear and deterioration status of the sheet feeding mechanism 2a without determining if the deceleration control is carried out every time the sheet 9 is fed. The image forming device 1 of the second embodiment does not perform the wear and deterioration detection when the sheet 9 after the second one is fed so that the increase in the burden due to the wear and deterioration detection during the processing of the print job may be prevented, resulting in improved processing efficiency of the print job.

In the example described above, the feeding time Ta and the sheet passing time Tb are also measured when the first sheet 9 is fed after the start of the processing of the print job. However, this is given not for limitation. When the first sheet 9 is fed after the start of the processing of the print job, the measurement of the feeding time Ta may not be performed or the measurement of the sheet passing time Tb may not be performed.

The structures and operations except for the structure and the operation described above in the second embodiment are the same as that in the first embodiment.

### Third Embodiment

The third embodiment of the present invention is explained next. When the following sheet 9 is continuously multifed in feeding of the sheet 9, for example, the deceleration control is continuously carried out by the sheet interval controller 42 and the sheet passing time Tb to use for the determination of the wear and deterioration status may not be obtained for a long time. According to the third embodiment, a rate of carrying out a control (deceleration control) to change the conveyance speed of the sheet 9 by the sheet interval controller 42 is calculated. When the carrying out rate gets equal to or more than a predetermined value, the feeding time is delayed to enable the sheet interval controller 42 not to carry out the control. The sheet passing time Tb used for determination of the wear and deterioration status of the sheet feeding mechanism 2a, therefore, may be obtained.

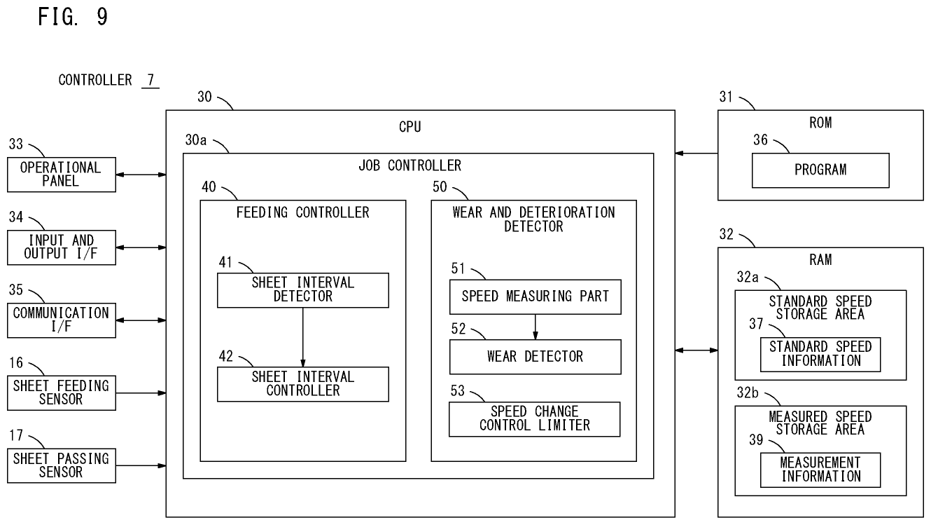

FIG. 9 illustrates a block diagram showing an example of the hardware structure and the functional structure of the controller 7 of the third embodiment. The difference between the controller 7 of the first embodiment and that of FIG. 9 is that the wear and deterioration detector 50 includes a speed change control limiter 53. The speed change control limiter 53 limits the control carried out by the sheet interval controller 42 based on the carrying out rate of the control to change the conveyance speed of the sheet (deceleration control) carried out by the sheet interval controller 42. To be more specific, the speed change control limiter 53 calculates the carrying out rate of the control by the sheet interval controller 42 and determines if the carrying out rate is equal to or more than a predetermined value. When the carrying out rate of the control by the sheet interval controller 42 is equal to or more than the predetermined value, the speed change control limiter 53 delays the feeding timing of the following sheet 9 and configures a restriction mode not to enable the sheet interval controller 42 to carry out the control. The speed change control limiter 53, for example, enables the feeding controller 40 to wait performing the feeding operation for a predetermined period of time to delay the timing to feed the following sheet 9 for the predetermined period of time. As a result, there will be an enough interval between the following sheet 9 to be fed next and the previous sheet 9, and the control by the sheet interval controller 42 is not carried out. The wear and deterioration detector 50 is enabled to obtain the sheet passing time Tb to use for the determination of the wear and determination status of the sheet feeding mechanism 2a while the control by the sheet interval controller 42 is not carried out. The deterioration detector 50 is enabled to determine the wear and deterioration status of the sheet feeding mechanism 2a based on the sheet passing time Tb.

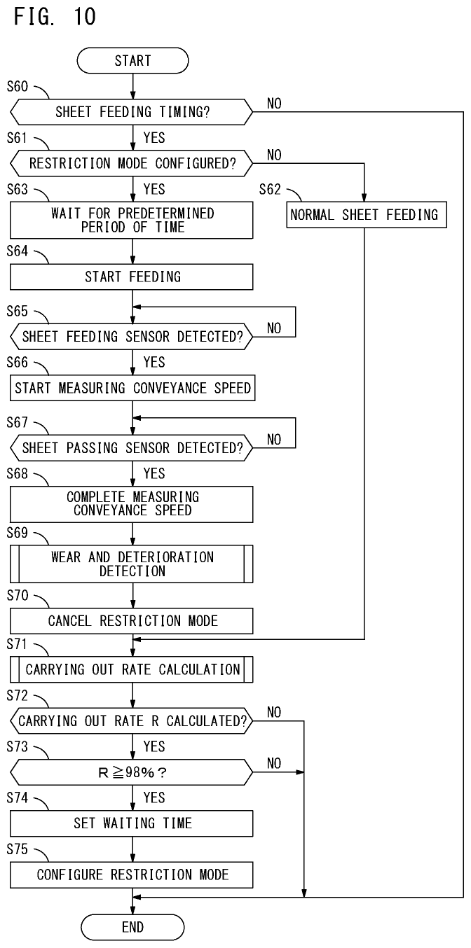

FIG. 10 illustrates a flow diagram explaining an exemplary procedure of the process performed in the image forming device 1 of the third embodiment. This flow diagram replaces the flow diagram of FIG. 6 explained in the first embodiment. Upon starting the process, the controller 7 determines if it is the sheet feeding timing to feed the sheet 9 (step S60). If it is not the sheet feeding timing (when a result of step S60 is NO), the process completes. If it is the sheet feeding timing (when a result of step S60 is YES), the controller 7 brings the feeding controller 40 into operation. The feeding controller 40 determines if the restriction mode is configured by the speed change control limiter 53 (step S61). When the restriction mode is not configured (when a result of step S61 is NO), the feeding controller 40 performs the regular feeding process (step S62). The regular feeding process is the same process as that explained by the flow diagram of FIG. 6, for example.

When the restriction mode is configured (when a result of step S61 is YES), the feeding controller 40 obtains a waiting time set by the speed change control limiter 53 and waits until an elapse of the waiting time (step S63). As a result, the sheet feeding timing of the following sheet 9 is delayed and the interval between the following sheet 9 and the previous sheet 9 is widened. After the elapse of the waiting time, the feeding controller 40 starts feeding the following sheet 9 (step S64). If the restriction mode is configured, the feeding controller 40 does not bring the sheet interval detector 41 and the sheet interval controller 42 into operation.

When the sheet 9 fed at a timing later than the sheet feeding timing is detected by the sheet feeding sensor 16 (when a result of step S65 is YES), the speed measuring part 51 starts measuring the sheet feeding time Tb equivalent to the conveyance speed (step S66). After the sheet 9 is detected by the sheet passing sensor 17 (when a result of step S67 is YES), the speed measuring part 51 completes the measurement of the sheet passing time Tb (step S68). During the process in steps S66 to S68, the deceleration control by the sheet interval controller 42 is not carried out. The sheet passing time Tb measured in step S68 can be used for the determination of the wear and deterioration status of the sheet feeding mechanism 2a. When the sheet passing time Tb is measured in the restriction mode, the image forming device 1 of the third embodiment brings the wear detector 52 into operation to perform the wear and deterioration detection (step S69). The detail of the wear and deterioration detection (step S69) is the same as the process explained in the flow diagram of FIG. 7. To be more specific, the wear detector 52 accumulates the predetermined number of sheet passing times Tb of the sheet 9 fed in the restriction mode, and calculates the average of the predetermined number of the sheet passing times Tb at the time when the predetermined number of the sheet passing times Tb are accumulated. The wear detector 52 determines wear status of the sheet feeding mechanism 2a based on the calculated average. As a result, the wear detector 52 may determine that the sheet feeding mechanism 2a is worn out. In this case, the wear detector 52 informs the user of the replacement of the sheet feeding mechanism 2a. After the wear and deterioration detection, the speed change control limiter 53 cancels the restriction mode (step S70). As a result, the sheet interval controller 42 is enabled to carry out the control to change the conveyance speed of the sheet 9.

The speed change control limiter 53 then performs a carrying out rate calculation (step S71). In this carrying out rate calculation, the carrying out rate of the control by the sheet interval controller 42 is calculated.

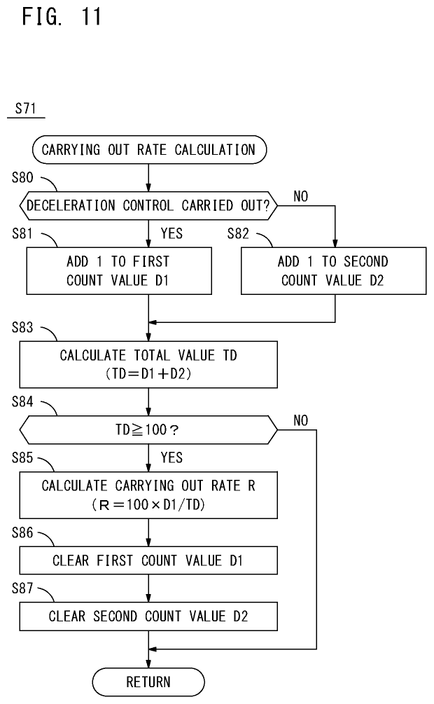

FIG. 11 illustrates a flow diagram explaining an exemplary procedure of the carrying out rate calculation (step S71) in detail. After starting the carrying out rate calculation, the speed change control limiter 53 determines if the deceleration control by the sheet interval controller 42 is carried out during the sheet feeding operation of the sheet 9 in the aforementioned step S62 or S64 (step S80). When the deceleration control by the sheet interval controller 42 is carried out (when a result of step S80 is YES), the speed change control limiter 53 adds 1 to a first count value D1. The first count value D1 is a count value of the number of times the deceleration control is carried out by the sheet interval controller 42. The deceleration control by the sheet interval controller 42 may not be carried out (when a result of step S80 is NO). In this case, the speed change control limiter 53 adds 1 to a second count value D2. The second count value D2 is a count value of the number of times the deceleration control is not carried out by the sheet interval controller 42.

The speed change control limiter 53 then calculates a total Td of the first and the second count values D1 and D2 (step S83), and determines if the total value TD is equal to or above a certain value (for instance, 100) (step S84). As a result, the total value TD may be less than the certain value (when a result of step S84 is NO). In this case, the carrying out rate calculation completes. The total value TD may be equal to or above the certain value (when a result of step S84 is YES). The speed change control limiter 53 then calculates a carrying out rate R of the deceleration control by the sheet interval controller 42 (step S85). The speed change control limiter 53 divides the first count value D1 by the total TD and the carrying out rate R is calculated. The speed change control limiter 53 then clears the first count value D1 to reset to zero (step S86), and also clears the second count value D2 to reset to zero (step S87). As described above, the carrying out rate calculation is complete. In the above-described carrying out rate calculation, the carrying out rate R is calculated every time the sheet feeding operation of the sheet 9 is performed for a predetermined number of times (for instance, 100 times). The predetermined number of times can be set to any number.

Referring back to the flow diagram of FIG. 10, the speed change control limiter 53 determines if the carrying out rate R is calculated in the carrying out calculation (step S71) (step S72). When the carrying out rate R is not calculated (when a result of step S72 is NO), the process by the speed change control limiter 53 completes. The carrying out rate R may be calculated (when a result of step S72 is YES). In this case, the speed change control limiter 53 determines whether or not the carrying out rate R is equal to or higher than a predetermined value (for instance, 98%) (step S73). When the carrying out rate R is lower than the predetermined value (when a result of step S73 is NO), the sheet passing time Tb usable for the determination of the wear and deterioration status is obtained to a moderate degree. The speed change control limiter 53, thus, completes the process without setting the restriction mode.

The carrying rate R may be equal to or higher than the predetermined value (when a result of step S73 is YES). In this case, the frequency of obtaining the sheet passing time Tb usable for the determination of the wear and deterioration status is decreasing. The speed change control limiter 53 then sets the waiting time to delay the sheet feeding operation at the sheet feeding timing (step S74). The time that ensures the enough interval between the sheets that does not enable the sheet 9 fed next catching up the first sheet 9 is set as the waiting time. The speed change control limiter 53 configures the restriction mode not to enable the sheet interval controller 42 to carry out the deceleration control (step S75). As a result, when the sheet 9 is fed next, the sheet feeding operation is performed at timing delayed from the sheet feeding timing. The sheet passing time Tb usable for the determination of the wear and deterioration status may be appropriately obtained. Thus, the process in the third embodiment completes.

The image forming device 1 of the third embodiment includes the speed change control limiter 53 that delays the sheet feeding timing at the sheet feeding mechanism 2a and restricts the sheet interval controller 42 to carry out the control of changing the conveyance speed of the sheet 9. When the carrying out rate R of the control to change the conveyance speed of the sheet 9 by the sheet interval controller 42 gets equal to or higher than the predetermined value. The wear detector 52 detects the wear and deterioration status of the sheet feeding mechanism 2a based on the sheet passing time Tb measured by the speed measuring part 51 while the carrying out of the control to change the conveyance speed of the sheet 9 by the sheet interval controller 42 is restricted by the speed change control limiter 53. When the deceleration control is continuously carried out by the sheet interval controller 42, the image forming device 1 of the third embodiment creates a situation where the deceleration control is not continuously carried out by the sheet interval controller 42 to obtain the sheet passing time Tb to use for the determination of the wear and deterioration status of the sheet feeding mechanism 2a. As a result, this may prevent a situation that the determination of the wear and deterioration status of the sheet feeding mechanism 2a cannot be performed for a long time, resulting in appropriate recognition of the wear and deterioration status of the sheet feeding mechanism 2a.

As described above, if the sheet passing time Tb usable for the determination of the wear and deterioration status of the sheet feeding mechanism 2a can be measured once during the restriction mode, the restriction mode is canceled. However, this is given not for limitation. The sheet passing time Tb usable for the determination of the wear and deterioration status of the sheet feeding mechanism 2a may be measured more than once during the restriction mode.

Some devices are designed to enable the sheet interval controller 42 to carry out the control to change the conveyance speed of the sheet 9 every time the sheet feeding operation of the sheet 9 is performed depending on device types of the image forming device 1. Such image forming device 1 has 100% carrying out rate of the control by the sheet interval controller 42. By applying the above-described process to the aforementioned image forming device 1, the sheet passing time Tb to be used for the determination of the wear and deterioration status of the sheet feeding mechanism 2a can be obtained every time a certain number of sheets 9 (for instance, 100 sheets) are fed. Hence, the technique described in the third embodiment is effective even for the image forming device 1 designed to enable the sheet interval controller 42 to carry out the control to change the conveyance speed of the sheet 9 every time.

The structures and operations except for the structure and the operation described above in the third embodiment are the same as that in the first or the second embodiment.

### Fourth Embodiment

The fourth embodiment of the present invention is explained next. The deceleration control to change the conveyance speed of the sheet 9 is mainly carried out by the sheet interval controller 42 in the above-described first to third embodiments. The control carried out by the sheet interval controller 42 is not necessarily the deceleration control. The control carried out by the sheet interval controller 42 may be acceleration control. The sheet interval controller 42 of the fourth embodiment carries out the acceleration control. The image forming device 1 of the fourth embodiment is the same as that of the first, the second and the third embodiments.

The image forming device 1 of the fourth embodiment widens the interval between the sheets and feeds the sheet at the continuous feeding of the multiple sheets 9 so that the following sheet 9 does not catch up the previous sheet 9. When the interval between the sheets is widened, the interval between the previous sheet 9 and the following sheet 9 is got further widened if the multifeeding is not occurred at the feeding of the previous sheet 9. This decreases throughput (number of produced outputs per unit time) in printing. In order to prevent decrease in the throughput, the sheet interval controller 42 of the fourth embodiment carries out the acceleration control to increase the conveyance speed of the sheet 9 when the interval between sheets is longer than the predetermined interval.

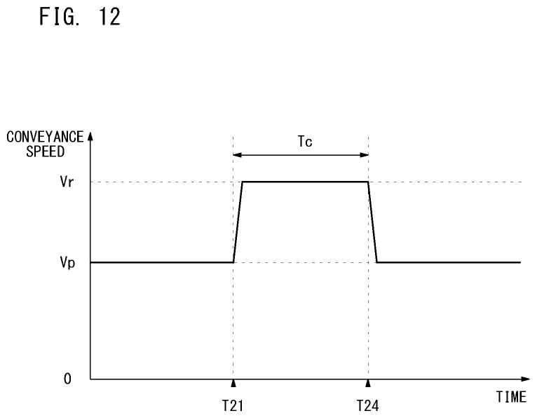

FIG. 12 illustrates an example of the acceleration control carried out by the sheet interval controller 42. After the sheet feeding operation by the feeding controller 40 is started, the interval between the sheets longer than the predetermined interval may be detected by the sheet interval detector 41. In such a case, the sheet interval controller 42 starts the acceleration control at timing T21. The sheet interval controller 42 determines the controlling time Tc to carry out the acceleration control depending on the interval between the sheets detected by the sheet interval detector 41. The sheet interval controller 42 maintains the increased conveyance speed of the sheet 9 which is higher than the predetermined speed Vp until elapse of the controlling time Tc from the start of the acceleration control. The sheet interval controller 42 then returns the conveyance speed of the sheet 9 back again to the predetermined speed Vp at time when the controlling time Tc is elapsed. The longer interval between the sheets has longer controlling time Tc.

As illustrated in FIG. 12, for example, the sheet interval controller 42 may increase the conveyance speed of the sheet 9 to a certain speed Vr which is higher than the predetermined speed Vp during the acceleration control. The sheet interval controller 42 maintains the speed Vr to carry out high speed conveyance of the sheet 9. The speed Vr may be, for instance, 1.5 times or double the speed Vp. Thus, the interval between the following sheet 9 and the previous sheet 9 gets shorter, resulting in prevention of decrease in the throughput.

As described above, once the acceleration control is carried out by the sheet interval controller 42, the acceleration control affects the sheet passing time Tb as well as the deceleration control as described above. The sheet passing time Tb measured during the acceleration control and the sheet passing time Tb measured while the acceleration control is not carried out cannot be used in the same manner. The wear detector 52 of the fourth embodiment determines the wear and deterioration status of the sheet feeding mechanism 2a based on the sheet passing time Tb measured by the speed measuring part 51 while the acceleration control is not carried out by the sheet interval controller 42. As a result, the wear and deterioration status of the sheet feeding mechanism 2a can be accurately detected.

The structures and operations except for the structure and the operation described above in the fourth embodiment are the same as that in the first embodiment. Also, in the fourth embodiment, the technique of determining the wear and deterioration status of the sheet feeding mechanism 2a using the sheet passing time Tb measured at the time the first sheet is fed after processing of the print job is started as described in the second embodiment may be applied.

As described in the third embodiment, the technique of restricting the acceleration control to be carried out by the sheet interval controller 42 when the carrying out rate R of the acceleration control by the sheet interval controller 42 is equal to or higher than the predetermined value, and detecting the wear and deterioration status of the sheet feeding mechanism 2a based on the sheet passing time Tb measured by the speed measuring part 51 during the restriction of the acceleration control may be applied. For applying the aforementioned technique described in the third embodiment to the image forming device 1 of the fourth embodiment, the process to delay the sheet feeding timing is not necessary to be performed.

### Fifth Embodiment

The fifth embodiment of the present invention is explained next. As described in the first, second, third and fourth embodiments, the wear and deterioration status of the sheet feeding mechanism 2a is detected based on the sheet passing time Tb measured by the speed measuring part 51 while the control is not carried out by the sheet interval controller 42. According to the fifth embodiment, the wear and deterioration status of the sheet feeding mechanism 2a is detected also using the sheet passing time Tb measured by the speed measuring part 51 during the control carried out by the sheet interval controller 42.

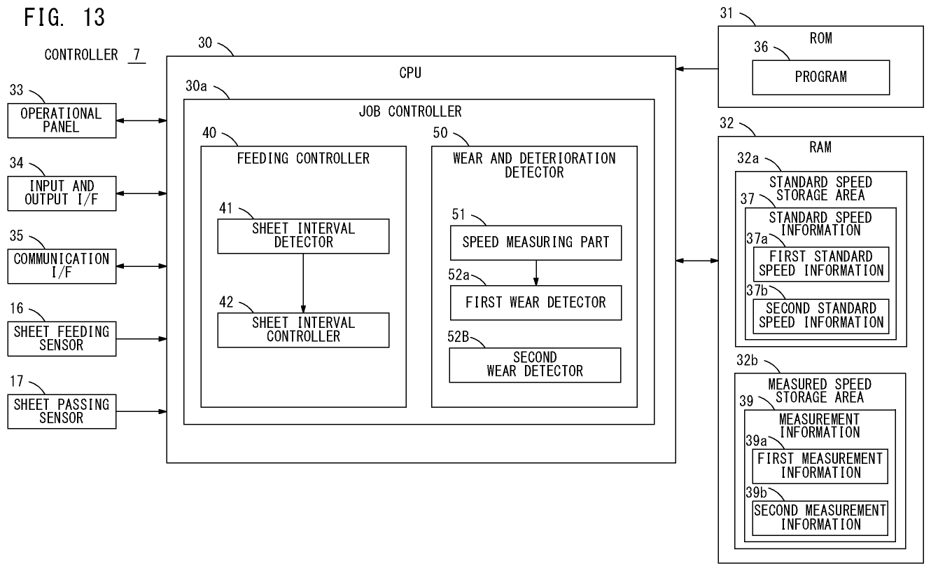

FIG. 13 illustrates a block diagram showing an example of the hardware structure and the functional structure of the controller 7 of the fifth embodiment. The difference between the controller 7 of the each above-described embodiment and that of the fifth embodiment is that the wear and deterioration detector 50 serves as two wear detectors, a first wear detector 52a and a second wear detector 52b.

In the fifth embodiment, a first standard speed 37a and a second standard speed 37b are recorded as the standard speed information 37 stored in the standard speed storage area 32a of the RAM 32. A standard value of the conveyance speed of the sheet 9 fed while the control is not carried out by the sheet interval controller 42 when while the sheet feeding roller 12 is not worn out is shown as the first standard speed 37a. The standard value of the sheet passing time required for the passage between the sheet feeding sensor 16 and the sheet passing sensor 17 when the sheet 9 is carried at a certain conveyance speed while the control is not carried out by the sheet interval controller 42 when the sheet feeding roller 12 is not worn out is recorded as the first standard speed 37a. A standard value of the conveyance speed of the sheet 9 fed with the control carried out by the sheet interval controller 42 during the feeding operation of the sheet 9 while the sheet feeding roller 12 is not worn out is shown as the second standard speed 37b. On the other hand, the standard value of the speed which is different from the speed recorded as the first standard speed 37a and slower than the speed recorded as the first second standard speed 37a is recorded as the second standard speed 37b. The standard value of the sheet passing time required for the passage between the sheet feeding sensor 16 and the sheet passing sensor 17 during the control carried out by the sheet interval controller 42 in the feeding operation while the sheet feeding roller 12 is not worn out is recorded as the second standard speed 37b. As described above, the image forming device 1 of the fifth embodiment distinctively holds the standard value for the case where the control by the sheet interval controller 42 is not carried out and the standard value for the case where the control by the sheet interval controller 42 is carried out.

According to the fifth embodiment, first measurement information 39a and second measurement information 39b sre stored as the measurement information 39 stored in the measured speed storage area 32b of the RAM 32. Information of the sheet passing time Tb measured while the control by the sheet interval controller 42 is not carried out during the feeding operation of the sheet 9 of the sheet passing times Tb measured by the speed measuring part 51 is recorded as the first measurement information 39a. Information of the sheet passing time Tb measured during the control by the sheet interval controller 42 in the feeding operation of the sheet 9 of the sheet passing times Tb measured by the speed measuring part 51 is recorded as the second measurement information 39b. The image forming device 1 of the fifth embodiment distinctively holds the measured value while the control by the sheet interval controller 42 is not carried out and the measured value while the control by the sheet interval controller 42 is carried out.

The first wear detector 52a detects the wear and deterioration status of the sheet feeding mechanism 2a based on the sheet passing time Tb measured by the speed measuring part 51 while the speed change control such as the deceleration control or the acceleration control is not carried out by the sheet interval controller 42. To be more specific, the first wear detector 52a has the same function as the wear detector 52 of the first, second, third and fourth embodiments. The first wear detector 52a becomes operative when the control by the sheet interval controller 42 is not carried out during the feeding operation of the sheet 9. The first wear detector 52a determines if the predetermined number (for instance, 100 times) of the sheet passing times Tb are stored as the first measurement information 39a. When the predetermined number of the passing times Tb are stored, the first wear detector 52a calculates the average of the predetermined number of the sheet passing times Tb. The first wear detector 52a compares the average and the standard value of the sheet passing time recorded as the first standard speed 37a so that it may detect the wear and deterioration status of the sheet feeding mechanism 2a, for instance.

The image forming device 1 of the fifth embodiment performs the different detection process depend on whether the control by the sheet interval controller 42 is carried out. Even when the control is carried out by the sheet interval controller 42, image forming device 1 is enabled to appropriately detect the wear and deterioration status based on the sheet passing time Tb.

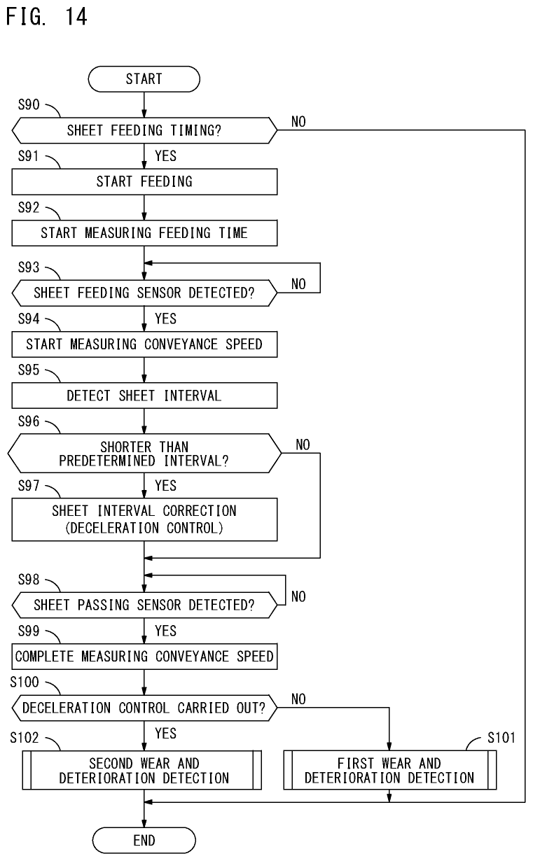

FIG. 14 illustrates a flow diagram explaining an exemplary procedure of the process performed in the image forming device 1 of the fifth embodiment. This flow diagram replaces the flow diagram in FIG. 6 explained in the first embodiment. The process in steps S90 to S99 in this flow diagram is the same as the process in steps S10 to S19 of FIG. 6. To be more specific, when the controller 7 determines it is the sheet feeding timing, the controller 7 starts feeding the sheet 9 and measures the sheet feeding time Ta. The controller 7 carries out the deceleration control if the interval between the sheets is shorter than the certain interval. If the interval between the sheets is equal to or longer than the certain interval, the controller 7 does not carry out the deceleration control. When the fed sheet 9 is detected by the sheet passing sensor 17 (when a result of step S98 is YES), the controller 7 completes measuring the conveyance speed of the sheet 9 (step S99). Hence, the controller 7 completes the measurement of the sheet passing time Tb that is correlated with the conveyance speed of the sheet 9.

After completing the measurement of the sheet passing time Tb, the speed measuring part 51 determines if the deceleration control by the sheet interval controller 42 is carried out during the measurement (step S100). When the deceleration control is not carried (when a result of step S100 is NO), the speed measuring part 51 brings the first wear detector 52a into operation. The first wear detector 52a performs a first wear and deteriorate detection (step S101). The detail of the first wear and deteriorate detection (step S101) is basically the same process as that in the flow diagram of

FIG. 7. To be more specific, the first wear detector 52a accumulates the predetermined number of the sheet passing times Tb measured by the speed measuring part 51 as the first measurement information 39a, and calculates the average of the predetermined number of the sheet passing times Tb once the predetermined number of the sheet passing times Tb are accumulated. The first wear detector 52a then compares the calculated average with the standard value of the first standard speed 37a to determine the wear of the sheet feeding mechanism 2a. As a result, when determining that the sheet feeding mechanism 2a is worn out, the wear detector 52 performs the wear warning to request the user for the replacement of the sheet feeding mechanism 2a.

When the deceleration control is carried during the measurement of the sheet passing time Tb (when a result of step S100 is YES), the speed measuring part 51 brings the second wear detector 52b into operation. The second wear detector 52b performs a second wear and deteriorate detection (step S102). The detail of the second wear and deteriorate detection (step S102) is also basically the same process as that in the flow diagram of FIG. 7. To be more specific, the second wear detector 52a accumulates the predetermined number of the sheet passing times Tb measured by the speed measuring part 51 as the second measurement information 39b, and calculates the average of the predetermined number of the sheet passing times Tb once the predetermined number of the sheet passing times Tb are accumulated. The second wear detector 52b then compares the calculated average with the standard value of the second standard speed 37b to determine the wear of the sheet feeding mechanism 2a. As a result, when determining that the sheet feeding mechanism 2a is worn out, the wear detector 52 performs the wear warning to request the user for the replacement of the sheet feeding mechanism 2a.

As described above, the image forming device 1 of the fifth embodiment collects the sheet passing time Tb measured while the control by the sheet interval controller 42 is carried out. The image forming device 1, therefore, collects not only the sheet passing time Tb measured while the control by the sheet interval controller 42 is not carried out but also not sheet passing time Tb measured while the control is carried out, and detects the wear and deterioration status of the sheet feeding mechanism 2a. The image forming device 1 of the fifth embodiment handles separately the sheet passing time Tb measured while the control by the sheet interval controller 42 is not carried out and the sheet passing time Tb measured while the control by the sheet interval controller 42 is carried out. Hence, the wear and deterioration status of the sheet feeding mechanism 2a may be appropriately detected based on the sheet passing time Tb measured while the control by the sheet interval controller 42 is not carried out, also the wear and deterioration status of the sheet feeding mechanism 2a may be appropriately detected based on the sheet passing time Tb measured while the control by the sheet interval controller 42 is carried out. With this structure, even when the carrying out rate R of the control by the sheet interval controller 42 increases to an extremely high value, for example, the control by the sheet interval controller 42 is not restricted, resulting in an appropriate determination of the wear and deterioration status of the sheet feeding mechanism 2a.

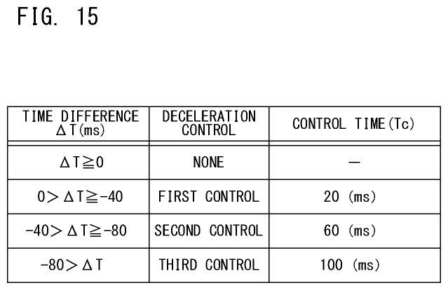

When the deceleration control by the sheet interval controller 42 is carried out, the control time Tc is not always constant. The control time Tc changes in accordance with the interval between the sheets detected by the sheet interval detector 41, for example. FIG. 15 illustrates an example of the control time Tc during the deceleration control carried out by the sheet interval controller 42. The sheet interval detector 41, for example, compares the sheet feeding time Ta with a predetermined appropriate time Tx to calculate a time difference ΔT (ΔT=Ta−Tx). If the time difference ΔT is a negative value, this means the interval between the sheets is narrower than the predetermined interval. In this case, the control by the sheet interval controller 42 is carried out. The sheet interval controller 42 selects one of the multiple deceleration controls based on the time difference ΔT, and carries out the selected deceleration control. It is assumed, for example, the time differenceΔT is 0>ΔT≥−40 ms, the sheet interval controller 42 selects a first control that enables the control time Tc to be 20 ms. It is assumed the time difference ΔT is −40 ms>ΔT≥80 ms, the sheet interval controller 42 selects a second control that enables the control time Tc to be 60 ms. It is assumed that the time difference ΔT is −80 ms>ΔT, the sheet interval controller 42 selects the third control that enables the control time Tc to be 100 ms. As described above, for carrying out the deceleration control, the sheet interval controller 42 selects one of the multiple deceleration controls depending on the interval between the sheets, and changes the control time Tc based on the interval between the sheets.

As described above, when the control time Tc of the acceleration control by the sheet interval controller 42 changes depending on the interval between the sheets, the sheet passing time Tb measured by the speed measuring part 51 is affected by the control time Tc. The sheet passing time Tb measured while the deceleration control is carried out by the sheet interval controller 42, therefore, cannot be processed in the same way. The multiple determination standard values corresponding to the respective multiple deceleration controls carried out by the sheet interval controller 42 are preferably stored in advance as the second standard speed 37b.

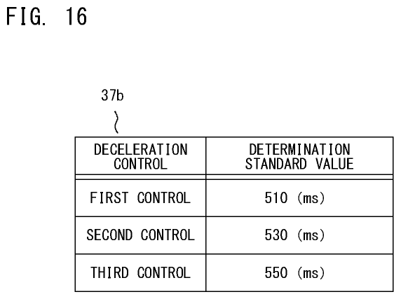

FIG. 16 illustrates an example of the multiple determination standard values stored in advance as the second standard speed 37b. The second standard speed 37b shows, for example, 510 ms recorded as the determination standard value for the case where the first control is carried out, 530 ms recorded as the determination value for the case where the second control is carried out, and 550 ms recorded as the determination value for the case where the third control is carried out. As described above, the multiple determination standard values are stored in advance as the second standard speed 37b so that the second wear detector 52b is enabled to select and read one of the multiple determination standard values appropriate for the of the deceleration control carried out by the sheet interval controller 42. The second wear detector 52b compares the sheet passing time Tb measured by the speed measuring part 51 with the single determination standard value thereby selected so that the wear and deterioration status of the sheet feeding mechanism 2a may be appropriately detected.

As described above, the image forming device 1 of the fifth embodiment detects the wear and deterioration status of the sheet feeding mechanism 2a based on the sheet passing time Tb measured during the deceleration control by the sheet interval controller 42 by the speed measuring part 51. This structure enables detection of the wear and deterioration status of the sheet feeding mechanism 2a without restriction of the deceleration control even when the deceleration control is carried out by the sheet interval controller 42 almost every time.

As described above, the deceleration control is mainly carried out by the sheet interval controller 42. In the fifth embodiment, the control carried out by the sheet interval controller 42 is not necessarily the deceleration control. The sheet interval controller 42 of the fifth embodiment may carry out the acceleration control. The sheet interval controller 42 may carry out both of the deceleration control and the acceleration control to constantly adjust the interval between the sheets to a certain interval.

The structures and operations except for the structure and the operation described above in the fifth embodiment are the same as that in the first, second, third and fourth embodiments.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### MODIFICATIONS

While the embodiments of the present invention have been described above, the present invention is not limited to the embodiments. Various modifications may be applied to the present invention.

In the above-described embodiment, for example, the image forming device 1 is constructed by a printer that only includes a printer function. However, this is given not for limitation. The image forming device 1 does not always have to be the printer. The image forming device 1, for example, may be constructed by a device such as one of MFPs (Multifunction Peripherals) including multiple functions. The aforementioned sheet feeder 1a is not necessarily equipped in the image forming device 1. The aforementioned sheet feeder la, for instance, is a device capable of detecting the wear and deterioration status of the sheet feeding mechanism 2a when the sheet feeding mechanism 2a feeds the sheet 9 one after the other. The image is not necessarily formed on the sheet 9 fed by the sheet feeding mechanism 2a. With that reason, the aforementioned sheet feeder 1a is also applicable to devices other than the image forming device 1.

The program 36 of the above-described embodiments executed by the CPU 30 is stored in advance in the ROM 31. The program 36 may be installed in the image forming device 1 via the communication interface 35, for example. In this case, the program 36 may be provided over an internet in a manner that enables a user to download, or may be provided in a manner that is recorded on a computer readable recording medium such as a CD-ROM or a USB memory.

What is claimed is:

1. A sheet feeder comprising:
a tray in which sheets are stored;
a feeding part that feeds the sheets stored in the tray; and
a hardware processor that:
measures a conveyance speed of the sheets fed by the feeding part;
compares the measured conveyance speed with a first standard speed and detects wear in the feeding part;
detects an interval between a previous sheet and a following sheet when the following sheet is continuously fed after the previous sheet; and
carries out a control to change the conveyance speed from a predetermined speed based on the detected interval to correct the interval between the previous sheet and the following sheet,
wherein the hardware processor detects the wear in the feeding part based on the conveyance speed measured while the control to change the conveyance speed is not carried out.

2. The sheet feeder according to claim 1, wherein
while the control to change the conveyance speed of the sheet is carried out, the hardware processor detects the wear in the feeding part without using the conveyance speed measured.

3. The sheet feeder according to claim 1, wherein
the hardware processor detects the wear in the feeding part based on the conveyance speed measured during a feeding operation of a first sheet of a job by the feeding part.

4. The sheet feeder according to claim 1, wherein the hardware processor further:
restricts carrying out of the control to change the conveyance speed when a carrying out rate of the control to change the conveyance speed becomes equal to or higher than a predetermined value,
wherein the hardware processor detects the wear in the feeding part based on the conveyance speed measured during the restriction of the control to change the conveyance speed.

5. The sheet feeder according to claim 1, wherein the hardware processor further:
compares the measured conveyance speed with a second standard speed and detects the wear in the feeding part,
wherein the hardware processor detects the wear in the feeding part based on the conveyance speed measured while the control to change the conveyance speed is carried out.

6. The sheet feeder according to claim 5, wherein the second standard speed is different from the first standard speed.

7. The sheet feeder according to claim 5, wherein
the hardware processor selects, as the second standard speed, one of the multiple determination standard values depending on the control, and compares the measured conveyance speed with the selected determination standard value.

8. The sheet feeder according to claim 1, wherein
when the detected interval between the sheets is narrower than a predetermined interval, the hardware processor reduces the conveyance speed to be lower than the predetermined speed.

9. The sheet feeder according to claim 1, wherein
when the detected interval between the sheets is narrower than a predetermined interval, the hardware processor temporarily stops conveyance.

10. The sheet feeder according to claim 1, wherein
when the detected interval between the sheets is wider than a predetermined interval, the hardware processor increases the conveyance speed to be higher than the predetermined speed.

11. An image forming device, comprising:
a sheet feeder; and
an image forming part that forms an image on a sheet fed by the sheet feeder,
wherein the sheet feeder comprising:
a tray in which sheets are stored;
a feeding part that feeds the sheets stored in the tray; and
a hardware processor that:
measures a conveyance speed of the sheets fed by the feeding part;
compares the measured conveyance speed with a first standard speed and detects wear in the feeding part;
detects an interval between a previous sheet and a following sheet when the following sheet is continuously fed after the previous sheet; and
carries out a control to change the conveyance speed from a predetermined speed based on the detected interval to correct the interval between the previous sheet and the following sheet,
wherein the hardware processor detects the wear in the feeding part based on the conveyance speed measured while the control to change the conveyance speed is not carried out.

12. A wear detecting method to detect a wear and deterioration status of a feeding part, the method applied at an image forming device comprising:
a tray in which sheets are stored; and
the feeding part that feeds the sheet stored in the tray,
wherein the method comprising:
measuring a conveyance speed of the sheet fed by the feeding part;
comparing the measured conveyance speed with a first standard speed and detecting the wear in the feeding part;
detecting an interval between a previous sheet and a following sheet when the following sheet is continuously fed after the previous sheet; and
carrying out a control to change the conveyance speed from a predetermined speed based on the detected interval to correct the interval between the previous sheet and the following sheet,
wherein the wear in the feeding part is detected based on the conveyance speed measured while the control to change the conveyance speed is not carried out.

13. The wear detecting method according to claim 12, wherein
while the control to change the conveyance speed of the sheet is carried out, the wear in the feeding part is detected without using the conveyance speed measured.

14. The wear detecting method according to claim 12, wherein
the wear in the feeding part is detected based on the conveyance speed measured during a feeding operation of a first sheet of a job by the feeding part.

15. The wear detecting method according to claim 12, further comprising:
restricting carrying out of the control to change the conveyance speed when a carrying out rate of the control to change the conveyance speed becomes equal to or higher than a predetermined value,
wherein the wear in the feeding part is detected based on the conveyance speed measured during the restriction of the control to change the conveyance speed.

16. The wear detecting method according to claim 12, further comprising:
comparing the measured conveyance speed with a second standard speed and detecting the wear in the feeding part,
wherein the wear in the feeding part is detected based on the conveyance speed measured while the control to change the conveyance speed is carried out.

17. The wear detecting method according to claim 16, wherein the second standard speed is different from the first standard speed.

18. The wear detecting method according to claim 16, wherein
one of multiple determination standard values is selected, as the second standard speed, depending on the control, and the measured conveyance speed is compared with the selected determination standard value.

19. The wear detecting method according to claim 12, wherein
when the detected interval between the sheets is narrower than a predetermined interval, the conveyance speed is reduced to a lower speed than the predetermined speed.

20. The wear detecting method according to claim 12, wherein
when the detected interval between the sheets is narrower than a predetermined interval, conveyance is temporarily stopped.

21. The wear detecting method according to claim 12, wherein
when the detected interval between the sheets is wider than a predetermined interval, the conveyance speed is increased to a higher speed than the predetermined speed.

22. A non-transitory recording medium storing a computer readable program to be executed by a hardware processor in an image forming device comprising:
a tray in which sheets are stored; and
a feeding part that feeds the sheet stored in the tray,
wherein the computer readable program causes the hardware processor executing the computer readable program to:
measure a conveyance speed of the sheet fed by the feeding part;
compare the measured conveyance speed with a standard speed and detecting wear in the feeding part;
detect an interval between a previous sheet and a following sheet when the following sheet is continuously fed after the previous sheet; and
carry out a control to change the conveyance speed from a predetermined speed based on the detected interval to correct the interval between the previous sheet and the following sheet,
wherein the wear in the feeding part is detected based on the conveyance speed measured while the control to change the conveyance speed is not carried out.
